(19) United States
(12) Patent Application Publication
(10) Pub. No.: US 2022/0203624 A1
(43) Pub. Date: Jun. 30, 2022

(54) BUILD PLATFORMS WITH CALIBRATION ELEMENTS

(71) Applicant: HEWLETT-PACKARD DEVELOPMENT COMPANY, L.P., Spring, TX (US)

(72) Inventors: Marc GARCIA GRAU, Sant Cugat del Valles (ES); Marta GONZALEZ MALLO, Sant Cugat del Valles (ES); Jorge DIOSDADO BORREGO, Sant Cugat del Valles (ES)

(21) Appl. No.: 17/604,706

(22) PCT Filed: Sep. 24, 2019
(86) PCT No.: PCT/US2019/052599

§ 371 Date: Oct. 18, 2021

(51) Int. Cl. B29C 64/393; B29C 64/245; B33Y 50/02; B33Y 30/00

(52) U.S. Cl. CPC B29C 64/393; B33Y 30/00; B33Y 50/02; B29C 64/245

(57) ABSTRACT

A build platform of an additive manufacturing apparatus is disclosed. The build platform includes a surface formed of a material having a first emissivity; and a plurality of reference markers disposed on the surface. The reference markers have a second emissivity that is different from the first emissivity. A thermal imaging unit calibration method and additive manufacturing apparatus are also disclosed.

### BACKGROUND

Additive manufacturing systems may be used to generate three-dimensional objects on a layer-by-layer basis by forming successive layers of build material on a build platform, and causing portions of the build material to selectively solidify or coalesce.

An additive manufacturing apparatus may use a thermal sensor to measure a temperature of a component of the apparatus, and the thermal sensor may be calibrated in order to improve the accuracy of its readings.

### BRIEF DESCRIPTION OF DRAWINGS

Examples will now be described, by way of non-limiting example, with reference to the accompanying drawings, in which:

FIG. 1 is a schematic illustration of an example of a build platform of an additive manufacturing apparatus;

FIG. 2A is a schematic illustration of a further example of a build platform;

FIG. 2B is a schematic illustration of a further example of a build platform;

FIG. 3 is a flowchart of an example of a thermal imaging unit calibration method; and

FIG. 4 is a schematic illustration of an example of an additive manufacturing apparatus.

### DETAILED DESCRIPTION

Additive manufacturing techniques may generate a three-dimensional object through the solidification of a build material. In some examples, the build material may be a powder-like granular material, which may for example be a plastic, ceramic or metal powder. The properties of generated objects may depend on the type of build material and the type of solidification mechanism used. Build material may be deposited, for example on a print bed and processed layer by layer, for example within a fabrication chamber. According to one example, a suitable build material may be PA12 build material commercially known as V1R10A “HP PA12” available from HP Inc.

In some examples, selective solidification is achieved through directional application of energy, for example using a laser or electron beam which results in solidification of build material where the directional energy is applied. In other examples, print agent(s) may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated (which may for example be generated from structural design data). The fusing agent may have a composition which absorbs energy such that, when energy (for example, heat) is applied to the layer, the build material coalesces and solidifies to form a slice of the three-dimensional object in accordance with the pattern.

According to one example, a suitable fusing agent may be an ink-type formulation comprising carbon black, such as, for example, the fusing agent formulation commercially known as V1Q60A “HP fusing agent” available from HP Inc. In one example such a fusing agent may additionally comprise an infra-red light absorber. In one example such a fusing agent may additionally comprise a near infra-red light absorber. In one example such a fusing agent may additionally comprise a visible light absorber. In one example such a fusing agent may additionally comprise a UV light absorber. Examples of print agents comprising visible light enhancers are dye based colored ink and pigment based colored ink, such as inks commercially known as CE039A and CE042A available from HP Inc.

In other examples, coalescence may be achieved in some other manner.

In addition to a fusing agent, in some examples, a print agent may comprise a coalescence modifying agent (referred to as modifying or detailing agents herein after), which acts to modify the effects of a fusing agent for example by reducing or increasing coalescence or to assist in producing a particular finish or appearance to an object, and such agents may therefore be termed detailing agents. A detailing agent (also termed a “coalescence modifier agent” or “coalescing modifier agent”) may, in some examples, have a cooling effect. In some examples, the detailing agent may be used near edge surfaces of an object being printed. According to one example, a suitable detailing agent may be a formulation commercially known as V1Q61A “HP detailing agent” available from HP Inc. A coloring agent, for example comprising a dye or colorant, may in some examples be used as a fusing agent or a modifying agent, and/or as a print agent to provide a particular color for the object.

As noted above, additive manufacturing systems may generate objects based on structural design data. This may involve a designer generating a three-dimensional model of an object to be generated, for example using a computer aided design (CAD) application. The model may define the solid portions of the object. To generate a three-dimensional object from the model using an additive manufacturing system, the model data can be processed to generate slices of parallel planes of the model. Each slice may define a portion of a respective layer of build material that is to be solidified or caused to coalesce by the additive manufacturing system.

An example additive manufacturing apparatus may include a print bed, or build platform, onto which a layer of build material may be formed. The additive manufacturing apparatus may also include a build material distributor to distribute or form build material on the print bed. In some examples, the additive manufacturing apparatus may include a source of radiation, or multiple sources of radiation, to direct radiation towards the print bed. The source of radiation may comprise a heat lamp or multiple heat lamps, such as an infrared lamp, which may be positioned above the print bed such that radiation is directed downwards towards the print bed. The source of radiation may, in some examples, include a pre-heating lamp or multiple pre-heating lamps for pre-heating the build material and/or a fusing lamp or multiple fusing lamps for applying heat to fuse portions of the build material. The additive manufacturing apparatus may also include an agent distributor to distribute agent, such as fusing agent and/or detailing agent, onto the layer of build material formed on the print bed. The agent distributor may include a set of nozzles or multiple sets of nozzles through which the print agent may be distributed onto the build material, each set of nozzles having an individual nozzle or multiple individual nozzles. The nozzles and/or the sets of nozzles may form part of a print head which, in some examples, may be a thermal print head or a piezo print head. The agent distributor may be movable relative to the print bed such that print agent may be selectively deposited, for example drop-by-drop, onto a portion of the layer of build material in a pattern derived from data representing a slice of the three-dimensional object to be built.

The agent distributor may be movable at least in a plane parallel to the print bed between a rest configuration, in which the agent distributor can be considered inactive or idle, and an active configuration, in which the agent distributor can distribute the print agent in accordance with the pattern.

The build platform, or print bed, may, in some examples, be positioned within, or form part of, a fabrication chamber (also referred to as a build chamber), in which a three-dimensional object may be built using the additive manufacturing techniques discussed herein.

The additive manufacturing apparatus, or a component thereof, may include a component to apply thermal energy (e.g. heat) to a part, or parts, of the additive manufacturing apparatus, in addition to the heat lamps mentioned above. In one example, thermal energy may be applied using a thermal blanket that is in thermal communication with, and/or that forms a part of, walls of the fabrication chamber and/or the print bed. During use, thermal energy may be applied to a component in order to raise the temperature of that component, for example to an operating temperature suitable for the additive manufacturing process.

The additive manufacturing apparatus may include a thermal sensor, such as a thermal imaging camera, that is positioned such that a temperature or temperatures of the print bed can be measured. Other sensors may be provided to measure temperatures of, or near to, particular components of the additive manufacturing apparatus. For example, a sensor may be provided to measure a temperature of the print bed. The sensor may be located in or close to the print bed itself, so that the measurements it takes are not affected by the same factors that affect the measurements acquired by the thermal sensor discussed above. In some examples, multiple sensors may be provided to measure temperatures of the print bed. For example, a plurality of sensors may measure temperatures at various locations on the print bed.

The thermal sensor may, in some examples, also be used to measure temperatures of layers of build material as they are being processed on the print bed. However, various factors may affect the accuracy of measurements made using the thermal sensor. Such factors include, for example, distortion effects experienced by the thermal sensor when capturing thermal image data. Such effects cause images acquired by the thermal sensor to be distorted, such that parts of the acquired image may distorted or displaced relative to other parts of the acquired image. Distortion effects occurring in acquired images may lead to defects in objects that are manufactured using the additive manufacturing apparatus, for example if the thermal sensor has been installed incorrectly, such that the thermal sensor is rotated or inclined relative to the print bed. It is also intended that the thermal sensor can accurately determine the relative positions of objects being generated in the fabrication chamber as the temperature of build material deposited between the objects is to be determined and controlled during an additive manufacturing process.

According to various examples of the present disclosure, a mechanism is provided by which a thermal sensor can be calibrated such that distortion effects occurring in images acquired using the thermal sensor can be mitigated or compensated for. Specifically, examples of a build platform are described which can be used in a calibration process for calibrating a thermal sensor, examples of a thermal imaging unit calibration method are described, and examples of additive manufacturing apparatus having a build platform and processing apparatus for performing a thermal sensor calibration process are described.

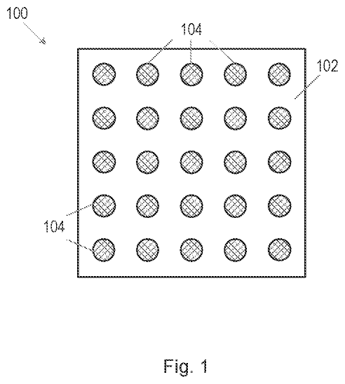

Referring to the drawings, FIG. 1 is a schematic illustration of a build platform 100 (sometimes referred to as a print bed) which may form part of an additive manufacturing apparatus (not shown in FIG. 1). As noted above, the build platform 100 may form part of, or may be used in conjunction with, a fabrication chamber used for generating a three-dimensional object in an additive manufacturing process. During such an additive manufacturing process, successive layers of build material may be deposited onto the build platform 100, and portions of the build material may be caused to solidify and/or coalesce various agents deposited onto the build material. The build platform 100 comprises a surface 102 formed of a material having a first emissivity. A material's emissivity may be expressed in terms of an emissivity coefficient, ε. In some examples, the material may comprise a metal. For example, the build platform 100 may be formed from steel. Polished steel has an emissivity coefficient of 0.07 at a temperature of 300 K, while mild steel has an emissivity coefficient of around 0.26 at a temperature of 300 K.

The build platform 100 also comprises a plurality of reference markers 104 disposed on the surface. The reference markers 104 (which may be referred to as calibration elements or calibration indicators) have a second emissivity that is different from the first emissivity. It is intended that the second emissivity is sufficiently different from the first emissivity that a distinction between the first emissivity and the second emissivity can be made in an image acquired using the thermal sensor. In other words, it is intended that reference markers 104 can be distinguished from the surface 102 of the build platform 100 in a thermal image (e.g. an image acquired using the thermal sensor).

In the example shown in FIG. 1, build platform 100 includes 25 reference markers 104 disposed on its surface 102, in a matrix arrangement of 5×5. In other examples, more or fewer reference markers 104 may be disposed on the surface 102, and the reference markers may be disposed in some other arrangement. In the example shown in FIG. 1, the reference markers 104 comprise circular markers; in other examples, however, reference markers of other shapes (e.g. geometric shapes such as squares, triangles, pentagons and the like, or other, non-geometric shapes or patterns) may be used. In some examples, the reference markers 104 may be arranged in a non-linear way, rather than in a linear fashion as shown in the example of FIG. 1.

Reference markers 104 may be considered to be patches, areas or regions that are visibly and/or thermally identifiable with respect to the surface 102 of the build platform 100. The reference markers 104 may be formed or created on the surface 102 of the build platform 100 when the platform is manufactured (i.e. as part of the manufacturing process), or after manufacturer of the build platform, before the build platform is used in an additive manufacturing process. Thus, the reference markers 104 may form a permanent part of the build platform 100, such that once they have been formed on the surface 102, they are not intended to be removed, and may form an integral part of the build platform.

In some examples, the reference markers 104 may be formed of paint. Thus, during or after the manufacturer of the build platform 100, the plurality of reference markers 104 may be painted onto the surface 102 of the build platform. The reference markers 104 may be painted onto the surface 102 manually (e.g. by a human) or automatically (e.g. using a machine and/or programmable apparatus). In some examples, the reference markers 104 may be formed of a paint that has a defined emissivity (i.e. a second emissivity) that is different from the first emissivity of the surface material. While it is envisaged that any paint may be used for forming the reference markers 104 on the surface 102, it will be apparent that the paint used is to be suitable for use within a fabrication chamber of an additive manufacturing apparatus and, therefore, is to be suitable for use in temperatures likely to be experienced within such a fabrication chamber. In one example, the reference markers 104 may be formed of latex.

In some examples, the reference markers 104 may be adhered to the surface 102 of the build platform 100. For example, the reference markers 104 may be formed as individual elements that are to be adhered or stuck (e.g. using glue or some other suitable adhesive) onto the surface 102. The reference markers 104 may be adhered or stuck onto the surface 102 manually (e.g. by a human) or automatically (e.g. using a machine and/or programmable apparatus). In this example, the individual elements to be used as the reference markers 104 may be formed from a material that is different from the surface material, and that has an emissivity that is different from the emissivity of the surface material. Thus, in other words, the surface 102 may be formed from a first material (e.g. metal, such as steel) that has a first emissivity, and the reference markers 104 may be formed from a second material (e.g. a polymeric material, such as latex) that has a second emissivity, different from the first emissivity.

In some examples, the reference markers 104 may comprise regions in which the surface 102 has an increased roughness. For example, the reference markers 104 may be formed by creating discrete patches on the surface 102 of the build platform 100 where a surface roughness is greater than the areas of the surface outside the patches. For example, the surface 102 may be generally relatively smooth, and the discrete patches forming the reference markers 104 may be relatively rough. The regions of increased roughness may be formed using mechanical techniques that will be familiar to those skilled in the relevant field. For example, regions of increased roughness may be formed by grinding, brushing, sand blasting, metal blasting, or a combination of two or more of these techniques. The expression “discrete” as used herein is intended to refer to the patches or regions being spaced apart from one another.

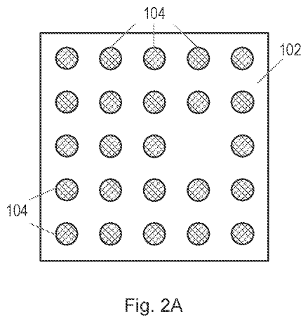

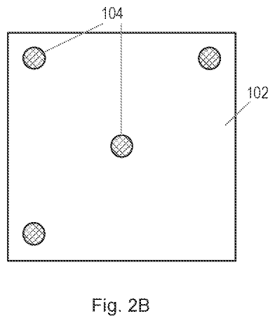

As discussed above, in the example shown in FIG. 1, the reference markers 104 are arranged in a 5×5 matrix, formed of 5 columns and 5 rows, in which the reference markers are arranged linearly. In other examples, however, the reference markers 104 may be arranged differently. In some examples, the plurality of reference markers may be arranged in a rotationally asymmetric manner. As used herein, the expression “rotationally asymmetric” is intended to describe an arrangement that appears the same if rotated by an integer number of complete rotations (i.e. of 360°), and does not appear the same after some partial rotation. FIGS. 2A and 2B each show a schematic illustration of an example of a build platform 100 having a surface 102, on which a plurality of reference markers 104 are arranged in a rotationally asymmetric manner. In FIG. 2A, 24 reference markers 104 are arranged in a rotationally asymmetric manner. In this example, the arrangement of reference markers 104 is similar to the arrangement shown in FIG. 1, with one of the reference markers omitted. In FIG. 2B, 4 reference markers 104 are arranged in a rotationally asymmetric manner. The arrangement shown in FIGS. 2A and 2B are just two examples of many possible arrangements in which reference markers 104 may be arranged in a rotationally asymmetric manner. A rotationally asymmetric arrangement of reference markers 104 provides a convenient way of determining an orientation of the build platform 100, for example for the thermal sensor capturing an image of the build platform and/or for an operator installing or positioning the build platform within the fabrication chamber. In some examples, the build platform 100 or the surface 102 thereof may be provided with some other marker or indicator (not shown) that can be used for orienting or aligning the build platform.

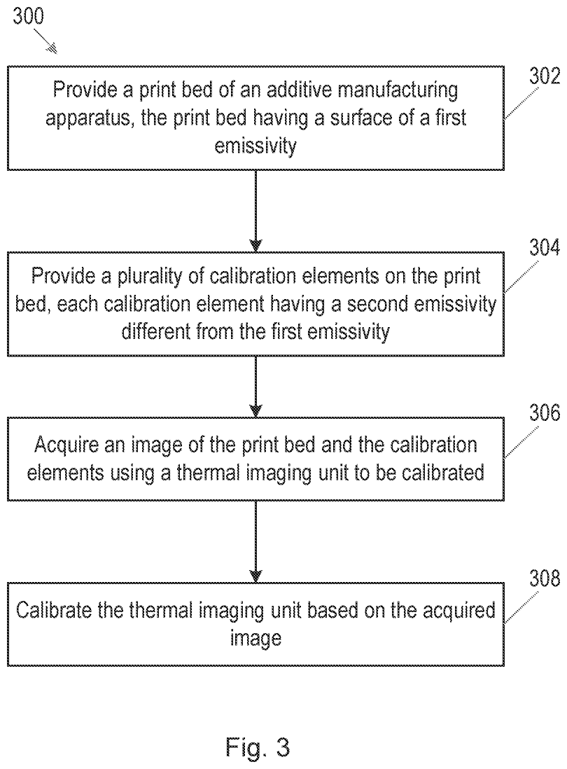

The build platform 100, with the plurality of reference markers 104 formed thereon may be used to calibrate a thermal imaging unit (e.g. a thermal sensor or a thermal imaging camera). For example, the arrangement of reference markers 104 may be used when calibrating a thermal imaging unit to be used with or in an additive manufacturing apparatus. FIG. 3 is a flowchart of an example of a method 300 which may, in some examples, be referred to as a thermal imaging unit calibration method. The method 300 comprises, at block 302, providing a print bed 100 (e.g. the build platform shown in FIGS. 1 and 2) of an additive manufacturing apparatus, the print bed having a surface 102 of a first emissivity. In some examples, the surface 102 of the print bed 100 may be formed of a first material (e.g. a metal such as steel) having the first emissivity. Providing the print bed 102 may, for example, comprise manufacturing and/or installing the print bed for use with the additive manufacturing apparatus. At block 304, the method 300 comprises providing a plurality of calibration elements 104 (e.g. the reference markers shown in FIGS. 1 and 2) on the print bed, each calibration element having a second emissivity different from the first emissivity. In some examples, calibration elements 104 may be formed from a second material, that is different from the first material from which the print bed is formed. The plurality of calibration elements 104 may be arranged in one of the arrangements shown in FIG. 1 or 2, or in any other arrangement, as discussed above. In some examples, providing the plurality of calibration elements 104 may comprise depositing paint onto the print bed 100 in a plurality of discrete positions, adhering to the print bed a plurality of discrete elements of a second material having the second emissivity, or forming on the print bed a plurality of discrete regions of greater relative roughness relative to the print bed. In other examples, providing the plurality of calibration elements 104 may involve forming the calibration elements on the print bed 100 in some other way.

The method 300 comprises, at block 306, acquiring an image of the print bed 100 and the calibration elements 104 using a thermal imaging unit (e.g. a thermal sensor or thermal imaging camera) to be calibrated. The image of the print bed 100 and calibration elements 104 may be acquired once the print bed and the thermal imaging unit have been installed (e.g. in the additive manufacturing apparatus), for example after manufacture, and before use of the additive manufacturing apparatus for an additive manufacturing process. In some examples, an image may be acquired prior to a new additive manufacturing process being performed. At block 308, the method 300 comprises calibrating the thermal imaging unit based on the acquired image. Calibration of the thermal imaging unit may be performed using calibration techniques that are familiar to those skilled in the relevant field, as discussed in greater detail below. Once calibrated, an image acquired using the thermal imaging unit is likely to more accurately reflect the true positions of objects shown in the image. Thus, by calibrating the thermal imaging unit, a region of the thermal image corresponding to the presence of an object can be matched to (e.g. determined to correspond to) an actual object in the fabrication chamber (and/or on the build platform). Accordingly, temperature measurements of other regions in the field of view of the thermal imaging unit may be made more accurately.

Calibrating the thermal imaging unit (at block 308) may, in some examples, comprise adjusting a parameter of the thermal imaging unit so as to reduce a degree of distortion occurring in an image acquired using the thermal imaging unit. The thermal imaging unit, which may comprise a thermal imaging camera, thermal sensor or the like, may experience various types of distortion (e.g. optical distortion) as a result of optical components included within the thermal imaging unit and/or as a result of inaccuracies introduced during manufacture or installation. In some examples, the thermal imaging unit may experience barrel distortion, sometimes referred to as fish-eye distortion, which leads to an apparent magnification of an acquired image that decreases with distance from the optical axis of the thermal imaging unit. In an image of the print bed 100 captured by a thermal imaging unit, barrel distortion may cause regions near to the edge of the print bed to appear curved or misaligned with other regions of the print bed. Thus, in some examples, calibrating (at block 308) the thermal imaging unit may comprise adjusting a parameter of the thermal imaging unit so as to reduce a degree of barrel distortion occurring in an acquired image.

In addition to distortion of an image acquired using the thermal imaging unit, the print bed 100 or other objects appearing in a captured image may appear displaced relative to their true positions (i.e. the actual positions of the objects relative to each other and to the print bed). For example, if a thermal imaging unit is installed such that it is tilted relative to the print bed 100, objects within the image (e.g. the reference markers or calibration elements 104, or objects that are being manufactured as part of an additive manufacturing process) may appear offset with respect to their true positions. Therefore, calibrating (at block 308) the thermal imaging unit may, in some examples, comprise adjusting relative positions of objects appearing in images acquired by the thermal imaging unit. For example, since the calibration elements 104 are arranged on the surface 102 of the print bed 100 in a defined arrangement, the relative positions of the calibration elements can be determined. When an image of the print bed 100 and the calibration elements 104 is captured using the thermal imaging unit, the apparent positions of the calibration elements in the captured image may be adjusted based on the true relative positions of the calibration elements. In this way, an appropriate adjustment or correction may be applied to future images acquired using the thermal imaging unit, such as images acquired during an additive manufacturing process.

Various techniques may be used for calibrating the thermal imaging camera based on the acquired image of the print bed 100 and the calibration elements 104, and these will be familiar to those skilled in the relevant field.

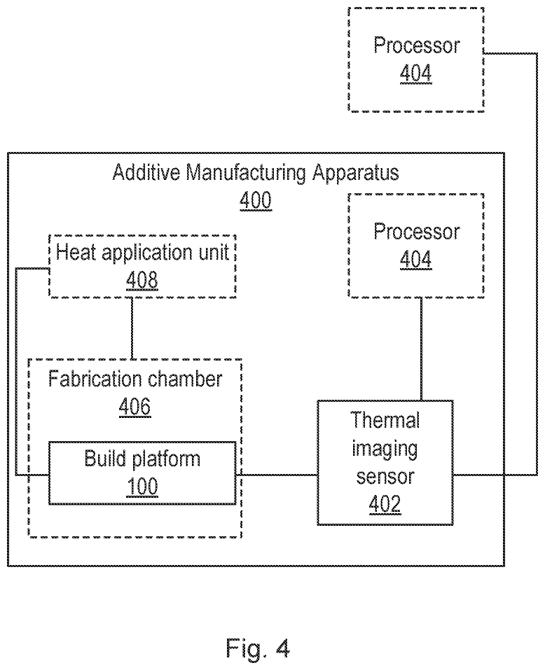

Examples of the present disclosure also provide an additive manufacturing apparatus. FIG. 4 is a schematic illustration of an example of an additive manufacturing apparatus 400. The additive manufacturing apparatus 400 comprises the build platform 100, a thermal imaging sensor 402 and a processor 404. The build platform 100 may form a part of, or may cooperate with, a fabrication chamber 406. However, as indicated by the dashed lines, the fabrication chamber 406 may itself not form part of the additive manufacturing apparatus 400. The build platform 100 comprises a build platform on which a three-dimensional object is to be built by processing successive layers of build material. The thermal imaging sensor 402 is to capture image data indicative of a temperature profile of the build platform 100. In some examples, the build platform 100 may form a base, or bottom wall, of the fabrication chamber 406, and the thermal imaging sensor 402 may be directed downwards, such that image data of the build platform is captured from above. Image data captured by the thermal imaging sensor 402 may indicate relative temperatures over a surface of the build platform 100.

The processor 404 may comprise a remote processor capable of communicating with components of the additive manufacturing apparatus 400, for example using wireless communication protocols, or a processor that forms part of the additive manufacturing apparatus 400 the processor 404 may receive data (e.g. measurements) from the thermal imaging sensor 402 for processing. In some examples, the processor 404 may control components of the additive manufacturing apparatus 400, such as components used during additive manufacturing process. According to various examples, the processor 404 is to operate the thermal imaging sensor 402 to capture image data indicative of a temperature profile of the build platform 100. The processor 404 is also to calibrate, based on the captured image data, the thermal imaging sensor 402 to correct for optical distortion. For example, the processor 404 may calibrate the thermal imaging sensor 402 to correct for optical distortion (e.g. barrel distortion) and/or object displacement appearing or occurring in image data captured by the thermal imaging sensor.

The processor 404 may perform functions by executing a set of instructions stored on a computer readable medium. Thus, in some examples, the additive manufacturing apparatus 400 may comprise or be associated with a storage medium (e.g. a memory) (not shown) that stores thermal imaging sensor operating instructions and thermal imaging sensor calibrating instructions which, when executed by the processor 404, cause the processor to perform the functions discussed above.

In some examples, the additive manufacturing apparatus 400 may further comprise a heat application unit 408 in thermal communication with the build platform 100, to provide heat to the build platform so as to increase a temperature of the build platform to a defined temperature. In FIG. 4, the heat application unit 408 is shown with a dashed lines to indicate that it is an optional feature. The heat application unit 408 (sometimes referred to as a thermal energy applicator) may, in some examples, comprise a thermal blanket, which may be formed in or around the walls of the fabrication chamber 406 so as to provide thermal energy (i.e. heat) to the fabrication chamber (e.g. to the walls of the fabrication chamber) and to the build platform 100. In some examples, the processor 404 may be in communication with the heat application unit 408, and may operate or control the heat application unit.

The build platform 100 of the additive manufacturing apparatus 400 may, in some examples, comprise a surface (e.g. surface 102) formed of a material having a first emissivity, and a plurality of reference markers (e.g. the reference markers or calibration elements 104) arranged on the surface, where the reference markers have a second emissivity that is different from the first emissivity. As with examples discussed above, the surface of the build platform 100 may be formed of a first material, such as metal (e.g. steel), and the reference markers may be formed from a second material, such as latex.

The reference markers may comprise markers that are painted on the surface, adhered to the surface or marked on the surface by etching or by forming regions of increased roughness. For example, the regions of increased roughness may have a surface roughness that is greater than the roughness of the rest of the surface. As used herein, the term “roughness” may be understood to be a roughness defined with respect to a profile or a surface of the build platform 100. Profile roughness of regions of the build platform 100 may be defined in terms of profile roughness parameters as included in the BS EN ISO 4287:2000 British standard.

Examples in the present disclosure can be provided as methods, systems or machine-readable instructions, such as any combination of software, hardware, firmware or the like. Such machine-readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that various flows and/or blocks in the flow charts and/or block diagrams, as well as combinations of the flows and/or diagrams in the flow charts and/or block diagrams can be realized by machine-readable instructions.

The machine-readable instructions may, for example, be executed by a general purpose computer, a special purpose computer, an embedded processor or processors of other programmable data processing devices to realize the functions described in the description and diagrams. In particular, a processor or processing apparatus may execute the machine-readable instructions. Thus functional modules of the apparatus and devices may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Such machine-readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A build platform of an additive manufacturing apparatus, the build platform comprising:
a surface formed of a material having a first emissivity; and
a plurality of reference markers disposed on the surface, wherein the reference markers have a second emissivity that is different from the first emissivity.

2. A build platform according to claim 1, wherein the plurality of reference markers are formed of paint.

3. A build platform according to claim 1, wherein the plurality of reference markers are adhered to the surface.

4. A build platform according to claim 1, wherein the plurality of reference markers comprise regions in which the surface has an increased roughness.

5. A build platform according to claim 1, wherein the plurality of reference markers are arranged in a rotationally asymmetric manner.

6. A build platform according to claim 1, wherein the material comprises a metal.

7. A thermal imaging unit calibration method comprising:
providing a print bed of an additive manufacturing apparatus, the print bed having a surface of a first emissivity;
providing a plurality of calibration elements on the print bed, each calibration element having a second emissivity different from the first emissivity;
acquiring an image of the print bed and the calibration elements using a thermal imaging unit to be calibrated; and
calibrating the thermal imaging unit based on the acquired image.

8. A thermal imaging unit calibration method according to claim 7, wherein providing the plurality of calibration elements comprises depositing paint onto the print bed in a plurality of discrete positions, adhering to the print bed a plurality of discrete elements of a second material having the second emissivity, or forming on the print bed a plurality of discrete regions of greater relative roughness relative to the print bed.

9. A thermal imaging unit calibration method according to claim 7, wherein calibrating the thermal imaging unit comprises adjusting a parameter of the thermal imaging unit so as to reduce a degree of distortion occurring in an image acquired using the thermal imaging unit.

10. A thermal imaging unit calibration method according to claim 7, wherein calibrating the thermal imaging unit comprises adjusting relative positions of objects appearing in images acquired by the thermal imaging unit.

11. A thermal imaging unit calibration method according to claim 7, wherein the distortion comprises barrel distortion.

12. An additive manufacturing apparatus comprising:
a build platform on which a three-dimensional object is to be built by processing successive layers of build material;
a thermal imaging sensor to capture image data indicative of a temperature profile of the build platform; and
a processor to:
operate the thermal imaging sensor to capture image data indicative of a temperature profile of the build platform; and
calibrate, based on the captured image data, the thermal imaging sensor to correct for optical distortion.

13. An additive manufacturing apparatus according to claim 12, further comprising:
a heat application unit in thermal communication with the build platform, to provide heat to the build platform so as to increase a temperature of the build platform to a defined temperature.

14. An additive manufacturing apparatus according to claim 12, wherein the build platform comprises a surface formed of a material having a first emissivity, and a plurality of reference markers arranged on the surface, wherein the reference markers have a second emissivity that is different from the first emissivity.

15. An additive manufacturing apparatus according to claim 14, wherein the reference markers comprise markers that are painted on the surface, adhered to the surface or marked on the surface by etching or by forming regions of increased roughness.
